(19) United States
(12) Patent Application Publication
(10) Pub. No.: US 2008/0031559 A1
(43) Pub. Date: Feb. 7, 2008

(54) Hybrid spherical bearing

(75) Inventors: Dhananjay Bhatt, Laguna Hills, CA (US); Oveis Nayeri, Anaheim Hills, CA (US); Robert Arnold, Port Ludlow, WA (US); Andrew Tyler, Fountain Valley, CA (US); Phillip Beausoleil, Mission Viejo, CA (US); Andy Lee, Santa Ana, CA (US)

Correspondence Address: MICHAUD-DUFFY GROUP LLP, 306 INDUSTRIAL PARK ROAD, SUITE 206, MIDDLETOWN, CT, 06457, US

(73) Assignee: Roller Bearing Company of America, Inc., Oxford, CT (US)

(21) Appl. No.: 11/827,692

(22) Filed: Jul. 13, 2007

Related U.S. Application Data
(60) Provisional application No. 60/830,906, filed on Jul. 13, 2006.

(51) Int. Cl. F16C 17/12; F16C 33/30

(52) U.S. Cl. 384/492

(57) ABSTRACT

In a hybrid spherical bearing, a ceramic ball is provided and has a bore extending at least part way there through. A metallic outer race is also provided and has an inner engagement surface contoured to a shape complementary to a shape defined by an outer diameter of the ceramic ball. The ceramic ball is positioned within the outer race and slidably and rotatably engages the inner engagement surface.

### CROSS REFERENCE TO RELATED APPLICATIONS

This application claims the benefit of U.S. Provisional Patent Application Ser. No. 60/830,906, filed Jul. 13, 2006, which is hereby incorporated by reference herein in its entirety.

### FIELD OF THE INVENTION

The present invention is generally related to spherical bearings and is more particularly directed to hybrid spherical bearings having both metallic and ceramic components.

### BACKGROUND OF THE INVENTION

Traditionally, spherical bearings have been comprised of a metallic ball positioned in a metallic outer race. The outer race defines an inner surface contoured to receive and retain the spherical ball in the outer race. The ball slides and rotates relative to the outer race. Because the spherical ball and the outer race are each metallic, it is necessary to provide lubricant between the spherical ball and outer race to allow the bearing to be operable for extended periods of time.

Spherical bearings are often positioned in machinery and vehicles in locations that are not easily accessible. This can make it difficult to maintain proper lubrication levels within the bearing. In addition, spherical bearings are often subjected to extreme operating environments. For example, these bearings can be subjected to temperature extremes wherein prolonged exposure can result in degradation of the mechanical properties of the bearing and corrosion of the metallic components.

### SUMMARY OF THE INVENTION

The present invention resides in one aspect in a hybrid spherical bearing that includes a ceramic ball having a bore extending at least partway therethrough. A metallic outer race having an inner engagement surface contoured to a shape complementary to a shape defined by an outer diameter of said ceramic ball is provided with the ceramic ball being positioned within the outer race and slidably and rotatably engaged with the inner engagement surface.

Preferably, the ceramic ball is made from silicon nitride. The outer race can be formed from, but is not limited to, steel, steel alloys, aluminum, aluminum alloys, magnesium, magnesium alloys, and the like. The silicon nitride preferably includes 3.7 to 4.7 percent by weight of aluminum, 3 to 4 percent by weight of yttrium, 0.4 to 0.8 percent by weight of titanium, 5.5 to 7.5 percent by weight of oxygen, 0 to 0.4 percent by weight of carbon, 0 to 0.1 percent by weight of magnesium, and 0 to 0.1 percent by weight of iron. While silicon nitride has been described as the material from which the spherical ball is made, the present invention is not limited in this regard as the spherical ball can be made from other materials such as zirconium and silicon carbide without departing from the broader aspects of the present invention.

In a preferred embodiment of the present invention, the hybrid spherical bearing includes at least one sleeve positioned in the bore defined by the spherical ball. The sleeve has an outer peripheral surface at least partly engaged with the bore wall. Preferably, the sleeve is held in place with an adhesive. The sleeve also defines a bore extending therethrough for receiving a portion of a shaft therein. In the preferred embodiment, the sleeve is metallic; however, the present invention is not limited in this regard as the sleeve can be made from any suitable material, as the particular application in which the spherical bearing is used demands. For example, the sleeve can be formed from a polymeric material without departing from the broader aspects of the present invention.

In another embodiment of the present invention, the hybrid spherical bearing includes a liner positioned between the outer race and the spherical ball. Preferably, the liner is made from a low friction polymeric material such as polytetetrafluoroethyline (PTFE); however, the present invention is not limited in this regard as, depending on the application, other polymeric liners can be employed. The liner can be made from a woven or non-woven material and can also include a rigid backing. In this embodiment, the liner is adhesively bonded to the inner engagement surface defined by the outer race.

An advantage of the present invention is that the ceramic ball reduces the friction between the outer race and the ceramic ball over that of traditional non-hybrid spherical bearings. Friction is further reduced via the use of the above-described liner.

Another advantage of the present invention is that the ceramic ball is more corrosion resistant then traditional metal balls and is also less dependent on lubrication.

### BRIEF DESCRIPTION OF THE DRAWINGS

FIG. 1 is a cross-sectional side view of an embodiment of the hybrid spherical bearing of the present invention without a liner between the outer race and the spherical ball.

FIG. 2 is an end view of the hybrid spherical bearing of FIG. 1.

FIG. 3 is a cross-sectional side view of an embodiment of the hybrid spherical bearing of the present invention with a liner portioned between the outer race and the spherical ball.

FIG. 4 is an end view of the hybrid spherical bearing of FIG. 3.

FIG. 5 is a cross-sectional side view of the ceramic spherical ball of the present invention having a pair of sleeves inserted therein.

FIG. 6 is a cross-sectional side view of one of the sleeves of FIG. 5.

FIG. 7 is an end view of the sleeve of FIG. 6.

### DETAILED DESCRIPTION OF THE PREFERRED EMBODIMENTS

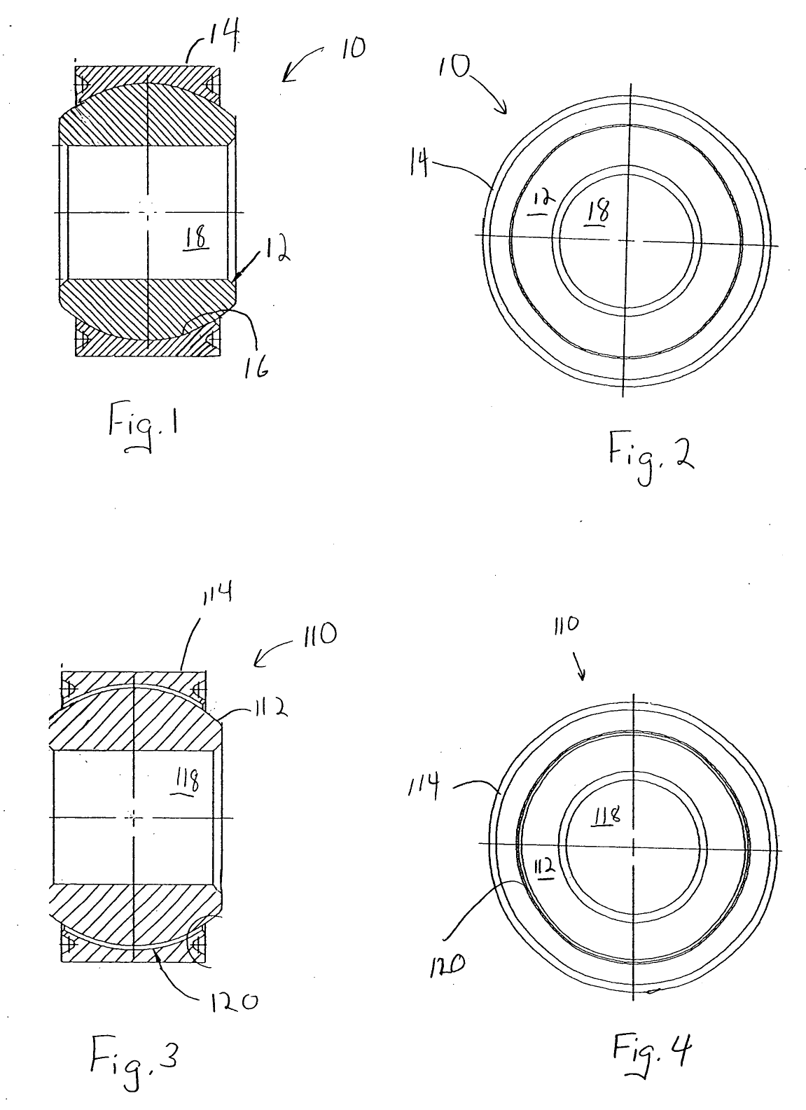

As shown in FIGS. 1 and 2, a hybrid spherical bearing generally designated by the reference number 10 includes a ceramic spherical ball 12 positioned in a metallic outer race 14 for sliding and rotation relative thereto. The metallic outer race 14 defines an inner engagement surface 16 that is contoured to a shape complementary to an outer diameter of the ceramic ball 12. During operation, the ceramic ball 12 slidably and rotatably engages the inner engagement surface 16. The ceramic ball 12 defines a bore 18 extending therethrough and adapted to receive a portion of a shaft (not shown), therein. The ceramic ball is made from a suitable material such as silicon nitride. A preferred silicon nitride includes 3.7 to 4.7 percent by weight of aluminum, 3 to 4 percent by weight of yttrium, 0.4 to 8.0 percent by weight of titanium, 5.5 to 7.5 percent by weight of oxygen, 0 to 0.4 percent by weight of carbon, 0 to 0.1 percent by weight of magnesium, and 0 to 0.1 percent by weight of iron. While silicon nitride has been described as the material from which the spherical ball is made, the present invention is not limited in this regard as the spherical ball can be made from other materials such as zirconium and silicon carbide without departing from the broader aspects of the present invention. The outer race can be formed from, but is not limited to, steel, steel alloys, aluminum, aluminum alloys, magnesium, magnesium alloys, and the like. While the bore 18 has been shown and described as extending through the ceramic ball, the present invention is not limited in this regard a the bore can also extend only partway through the ceramic ball.

Referring to FIGS. 3 and 4, another embodiment of a hybrid spherical bearing is shown and generally designated by the reference number 110. The hybrid spherical bearing 110 is similar to the hybrid spherical bearing 10 so that like elements are given like reference numbers preceded by the numeral 1. The hybrid spherical bearing 110 differs from the hybrid spherical bearing 10 in that it includes a liner 120 positioned between the ceramic spherical ball 112 and the metallic outer race 114. The liner 120 is formed from a low friction material, such as, but not limited to, PTFE. The liner can be woven or non-woven and can also include a rigid backing (not shown). While PTFE has been described, other suitable materials, such as metals impregnated with lubricant, or other polymers, dependent upon the particular application the hybrid spherical bearing will be employed in, can be substituted without departing from the broader aspects of the present invention.

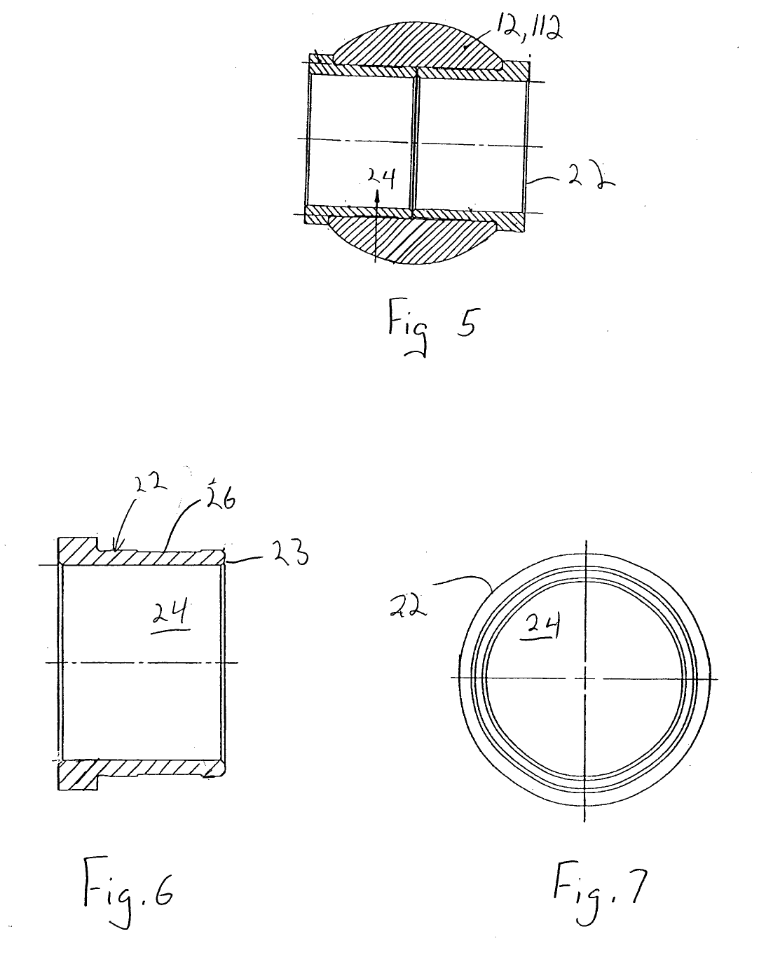

As shown in FIGS. 5-7, a pair of sleeves 22 can be positioned in the bore 18 of the ceramic ball 12 with an end face 23 of one sleeve 22 abutting a corresponding end face of the other sleeve. Each sleeve 22 also has a bore 24 extending therethrough and adapted to receive a portion of a shaft. The sleeves 22 can be metallic or formed from other suitable materials such as polymers dependent upon the environment wherein the hybrid spherical bearing will be used. The sleeves 22 each define an area 26 of reduced diameter. Adhesive is applied to the area 26 prior to insertion of a sleeve 22 into the bore 18 of the hybrid spherical bearing to retain the sleeve in the bore. While the bore 18 in the ceramic ball is shown and described as extending therethrough, the present invention is not limited in this regard as the bore 18 can extend partway through the ceramic ball 12 and only a single sleeve 22, or no sleeve, inserted therein.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above-detailed description, but that the invention will include all embodiments falling within the scope of the above description.

What is claimed is:

1. A hybrid spherical bearing comprising:
a ceramic ball having a bore extending at least part way there through;
a metallic outer race having an inner engagement surface contoured to a shape complementary to a shape defined by an outer diameter of said ceramic ball; and
said ceramic ball being positioned within said outer race and slidably and rotatably engaged with said inner engagement surface.

2. A hybrid spherical bearing as defined by claim 1 wherein said ceramic ball is formed from silicon nitride.

3. A hybrid spherical bearing as defined by claim 1 wherein said ceramic ball is formed from zirconium.

4. A hybrid spherical bearing as defined by claim 1 wherein said bore is defined by a bore wall, said hybrid spherical bearing further comprising at least one sleeve positioned in said bore, said sleeve having an outer peripheral surface at least partly engaged with said bore wall.

5. A hybrid spherical bearing as defined by claim 1 further comprising a lubricious liner positioned between said inner engagement surface and said outer diameter of said ceramic ball.

6. A hybrid spherical bearing as defined by claim 5 wherein said liner is attached to said inner engagement surface.

7. A hybrid spherical bearing as defined by claim 5 wherein said liner is formed from polytetrafluoroethylene (PTFE).

8. A hybrid spherical bearing as defined by claim 7 wherein said PTFE is woven.

9. A hybrid spherical bearing as defined by claim 7 wherein said PTFE is non-woven.

10. A hybrid spherical bearing as defined by claim 5 further comprising a rigid backing attached to said liner.

11. A hybrid spherical bearing defined by claim 4 wherein said bore extends through said ceramic ball and said at least one sleeve includes two sleeves positioned in said bore with an end face defined by one of said sleeves abutting an end face defined by the other of said sleeves.

12. A hybrid spherical bearing as defined by claim 4 wherein said sleeve is adhesively bonded to said ceramic ball.

13. A hybrid spherical bearing as defined by claim 12 wherein said sleeve includes an outer surface defined by an area of reduced diameter, and wherein an adhesive is positioned in said area of reduced diameter to adhesively bond said sleeve to said ceramic ball.

14. A hybrid spherical bearing comprising:
a ceramic ball having a bore extending at least part way there through;
a metallic outer race having an inner engagement surface contoured to a shape complementary to a shape defined by an outer diameter of said ceramic ball;
said ceramic ball being positioned within said outer race and slidably and rotatably engaged with said inner engagement surface;
said bore being defined by a bore wall, said hybrid spherical bearing further comprising at least one sleeve positioned in said bore, said sleeve having an outer peripheral surface at least partly engaged with said bore wall; and
a liner positioned between said inner engagement surface and said outer diameter of said ceramic ball.

15. A hybrid spherical bearing as defined by claim 14 wherein said liner is formed from PTFE.
